(19) United States
(12) Patent Application Publication
(10) Pub. No.: US 2026/0160901 A1
(43) Pub. Date: Jun. 11, 2026

(54) SATELLITE MANEUVER DETECTION APPARATUS BASED ON NEURAL CONTROLLED DIFFERENTIAL EQUATIONS AND OPERATION METHOD THEREOF

(71) Applicant: RESEARCH & BUSINESS FOUNDATION SUNGKYUNKWAN UNIVERSITY, Suwon-si (KR)

(72) Inventors: Kangjun LEE, Suwon-si (KR); Simon Sungil WOO, Suwon-si (KR)

(21) Appl. No.: 19/416,986

(22) Filed: Dec. 11, 2025

(30) Foreign Application Priority Data
Dec. 11, 2024 (KR) 10-2024-0183430

(51) Int. Cl. G01S 19/37; G06F 17/13

(52) U.S. Cl. CPC G01S 19/37; G06F 17/13

(57) ABSTRACT

A satellite maneuver detection apparatus and method thereof are provided. The method comprises acquiring observed orbit information of a satellite collected up to a target time, generating predicted orbit information for a time after the target time based on the observed orbit information using a pre-trained satellite orbit prediction model, generating an orbit prediction error by comparing the observed orbit information collected after the target time with the predicted orbit information, and determining a satellite maneuver status upon the orbit prediction error exceeding a predetermined error threshold.

### CROSS-REFERENCE TO RELATED APPLICATION

This application claims priority to Korean Patent Application No. 10-2024-0183430, filed on December 11, 2024, the entirety of which is incorporated herein by reference for all purposes.

### TECHNICAL FIELD

An embodiment relates to a technology for detecting the orbit and maneuver of a satellite based on Neural Controlled Differential Equations.

This work was supported by Institute of Information & communications Technology Planning & Evaluation (IITP) grant funded by the Korea government (Ministry of Science and ICT) (Project unique No.: 2710006749; Project No.: II221199; R&D project: Information, Communication, and Broadcasting Innovation Talent Development (R&D); Research Project Title: Graduate School of Convergence Security (Sungkyunkwan University); and Project period: 2024.01.01. ~ 2024.12.31.).

### BACKGROUND

Existing satellite orbit prediction has relied on physics-based models. However, such models do not perfectly reflect the uncertainties of the space environment and may cause high prediction errors due to unexpected environmental changes. Furthermore, performance significantly degrades in cases where there are missing values or irregular data sampling in satellite data. Although machine learning and deep learning techniques have been introduced to solve this, conventional methods have problems in that they do not sufficiently reflect the temporal dependencies of multivariate time-series data or are sensitive to noise. This degrades stability in satellite orbit prediction and maneuver detection, which increases the possibility of collision and may lead to significant damage.

### SUMMARY

The objective of an embodiment is to overcome the limitations that existing physics-based models have by proposing a deep learning model capable of performing high-performance prediction of satellite orbital elements and maneuver detection. In particular, an embodiment aims to maintain high prediction accuracy through a Neural Controlled Differential Equations-based model even when missing values or irregular sampling occur in satellite data, and to detect unexpected satellite maneuvers.

According to an aspect, a method to be performed by a satellite maneuver detection apparatus based on Neural Controlled Differential Equations comprises: acquiring observed orbit information of a satellite collected up to a target time; generating predicted orbit information of the satellite for a time after the target time using a pre-trained satellite orbit prediction model based on the observed orbit information of the satellite collected up to the target time, using a pre-trained satellite orbit prediction model; generating an orbit prediction error by comparing the observed orbit information of the satellite collected after the target time with the predicted orbit information; and determining the satellite maneuver status upon the orbit prediction error exceeding a predetermined error threshold.

In an embodiment, the pre-trained satellite orbit prediction model may be a model generated by training the NCDE-based model based on the observed orbit information of the satellite collected during a predetermined time interval.

In an embodiment, the pre-trained satellite orbit prediction model may be a model generated by training the NCDE-based model based on interpolated observed orbit information, which is obtained by interpolating missing data based on Cubic Hermite splines, if there are time points with missing data in the observed orbit information of the satellite collected during the predetermined time interval.

In an embodiment, the pre-trained satellite orbit prediction model may be a model generated by normalizing the interpolated observed orbit information and training the NCDE-based model.

In an embodiment, the pre-trained satellite orbit prediction model may be a model generated by normalizing the interpolated observed orbit information, converting it into a fixed-sized sequence using a sliding window technique, and then training the NCDE-based model.

In an embodiment, the generating the orbit prediction error may include the prediction error based on Mean Squared Error (MSE).

In an embodiment, the determining the satellite maneuver status may include the satellite maneuver status based on a semi-major axis error included in the predicted orbit information.

In an embodiment, the determining the satellite maneuver status may include that the satellite has maneuvered upon a spectral residual for the semi-major axis error exceeding a predetermined maneuver threshold.

In an embodiment, the predetermined maneuver threshold may be set based on a spectral residual value for the semi-major axis error that occurs during a satellite maneuver.

According to another aspect, a satellite maneuver detection apparatus based on Neural Controlled Differential Equations comprises: a memory including instructions; and a processor that, by executing the instructions, acquires observed orbit information of a satellite collected up to a target time, generates predicted orbit information, which is orbit information of the satellite predicted for a time after the target time, from the observed orbit information of the satellite collected up to the target time using a pre-trained satellite orbit prediction model, generates an orbit prediction error by comparing the observed orbit information of the satellite collected after the target time with the predicted orbit information, and determines the satellite maneuver status upon the orbit prediction error exceeding a predetermined error threshold.

According to still another aspect, a non-transitory computer-readable recording medium storing a computer program includes instructions for causing a processor to perform a method comprising: acquiring observed orbit information of a satellite collected up to a target time; generating predicted orbit information, which is orbit information of the satellite predicted for a time after the target time, from the observed orbit information of the satellite collected up to the target time, using a pre-trained satellite orbit prediction model; generating an orbit prediction error by comparing the observed orbit information of the satellite collected after the target time with the predicted orbit information; and determining the satellite maneuver status upon the orbit prediction error exceeding a predetermined error threshold.

According to the above aspects, prediction accuracy may be improved compared to existing physics-based models, and high performance in orbit prediction may be maintained even when there is data collected at irregular time intervals or missing values.

Furthermore, even if the output length used when training the model is different, prediction can still be performed by adjusting the output length in a test phase and in practice.

Furthermore, after training using KOMPSAT satellite data, the invention may be applied to various multi-purpose artificial satellites, and the model used for orbit prediction may be reused for maneuver detection, thereby increasing its versatility.

### BRIEF DESCRIPTION OF THE DRAWINGS

FIG. 1 is a block diagram of a satellite maneuver detection apparatus based on Neural Controlled Differential Equations according to an embodiment.

FIG. 2 is a flowchart of a satellite maneuver detection method based on Neural Controlled Differential Equations according to an embodiment.

FIG. 3 is a diagram for explaining a method of training a Neural Controlled Differential Equations-based model according to an embodiment.

FIG. 4 is a block diagram of a satellite maneuver detection apparatus based on Neural Controlled Differential Equations according to another embodiment.

### DETAILED DESCRIPTION

Advantages and features of the disclosure, and methods for achieving them, will become clear with reference to the embodiments described in detail below in conjunction with the accompanying drawings. However, the disclosure is not limited to the embodiments disclosed below and may be implemented in various forms. The present embodiments are provided only to make the disclosure complete and to fully convey the scope of the invention to those skilled in the art to which the present disclosure pertains. The scope of the invention is defined only by the claims.

In describing the embodiments, detailed descriptions of well-known functions or configurations will be omitted if they are not actually necessary for describing the embodiments. Terms described below are defined in consideration of functions in the embodiments and may vary depending on the intention of a user or operator, or custom.

Terms such as "unit" and "module" used hereinafter refer to a unit that processes at least one function or operation, which may be implemented as hardware, software, or a combination of hardware and software.

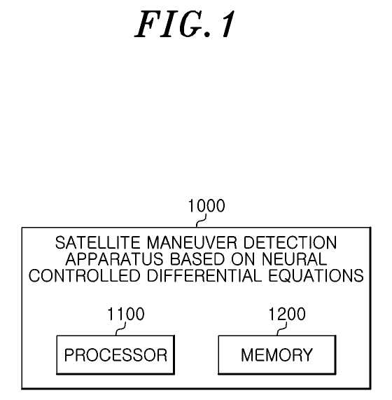

FIG. 1 is a block diagram of a satellite maneuver detection apparatus based on Neural Controlled Differential Equations according to an embodiment.

Referring to FIG. 1, the satellite maneuver detection apparatus 1000 based on Neural Controlled Differential Equations according to an embodiment may include a processor and a memory.

The processor may control the overall operation of the satellite maneuver detection apparatus 1000 based on Neural Controlled Differential Equations by executing instructions stored in the memory.

In an embodiment, the processor may predict the orbit and detect the maneuver of a satellite using a pre-trained satellite orbit prediction model based on Neural Controlled Differential Equations by executing instructions stored in the memory.

In an embodiment, the processor may train the satellite orbit prediction model based on Neural Controlled Differential Equations by executing instructions stored in the memory.

The memory may store instructions for the overall operation of the satellite maneuver detection apparatus 1000 based on Neural Controlled Differential Equations.

In an embodiment, the memory may store a pre-trained satellite orbit prediction model based on Neural Controlled Differential Equations.

In an embodiment, the memory may include instructions for predicting the orbit and detecting the maneuver of a satellite using the pre-trained satellite orbit prediction model based on Neural Controlled Differential Equations.

In an embodiment, the memory may store instructions necessary for training the satellite orbit prediction model based on Neural Controlled Differential Equations.

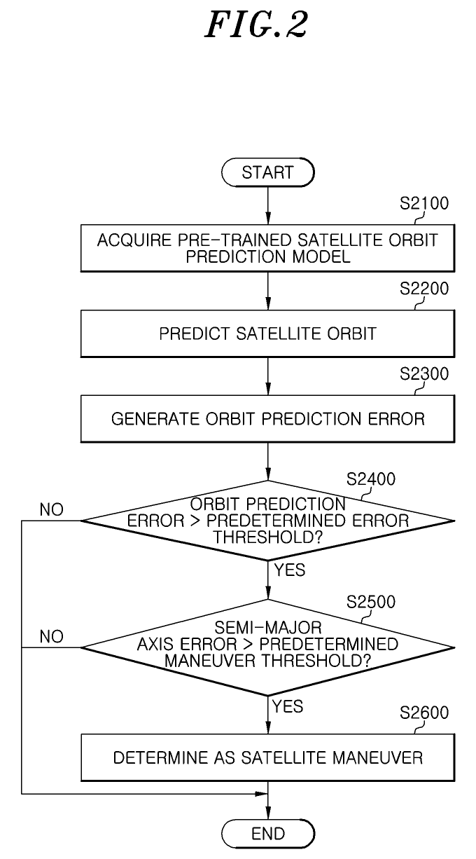

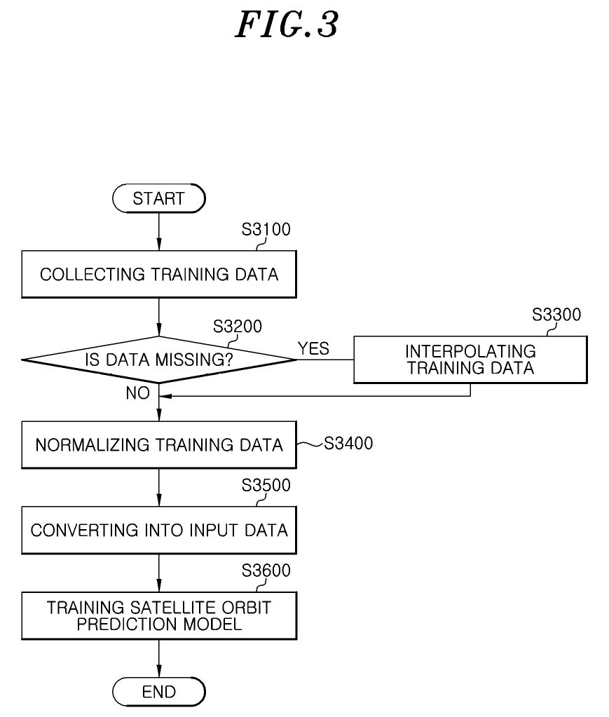

Hereinafter, specific operations of the satellite maneuver detection apparatus 1000 based on Neural Controlled Differential Equations will be described with reference to FIGS. 2 and 3.

FIG. 2 is a flowchart of a satellite maneuver detection method based on Neural Controlled Differential Equations according to an embodiment.

Hereinafter, the method will be described as being performed by the satellite maneuver detection apparatus 1000 based on Neural Controlled Differential Equations illustrated in FIG. 1, by way of example.

In step S2100, the satellite maneuver detection apparatus 1000 based on Neural Controlled Differential Equations may acquire a pre-trained satellite orbit prediction model based on Neural Controlled Differential Equations.

In an embodiment, the satellite maneuver detection apparatus 1000 based on Neural Controlled Differential Equations may acquire the model by receiving a pre-trained satellite orbit prediction model based on Neural Controlled Differential Equations from an external device.

In an embodiment, the satellite maneuver detection apparatus 1000 based on Neural Controlled Differential Equations may acquire the pre-trained satellite orbit prediction model based on Neural Controlled Differential Equations by training and fine-tuning a Neural Controlled Differential Equations-based model suitable for satellite orbit prediction.

In step S2200, the satellite maneuver detection apparatus 1000 based on Neural Controlled Differential Equations may acquire observed orbit information of the satellite collected during a predetermined time interval up to a target time, which is the time for which a prediction is to be made. The satellite maneuver detection apparatus 1000 based on Neural Controlled Differential Equations may generate predicted orbit information, which is orbit information of the satellite predicted for a time after the target time, from the observed orbit information using the pre-trained satellite orbit prediction model based on Neural Controlled Differential Equations.

In an embodiment, the observed orbit information may be time-series data collected during a predetermined time interval.

In an embodiment, the observed orbit information may include information such as the semi-major axis and semi-minor axis of the satellite.

In step S2300, the satellite maneuver detection apparatus 1000 based on Neural Controlled Differential Equations may generate an orbit prediction error by comparing the observed orbit information of the satellite collected at a time after the target time with the predicted orbit information.

In an embodiment, the satellite maneuver detection apparatus 1000 based on Neural Controlled Differential Equations may generate an orbit prediction error according to Mean Squared Error (MSE).

In step S2400, the satellite maneuver detection apparatus 1000 based on Neural Controlled Differential Equations may verify whether the orbit prediction error exceeds a predetermined orbit error by comparing the orbit prediction error with the predetermined orbit error.

In an embodiment, the predetermined orbit error is an error value that may occur during a satellite maneuver and may be predetermined or changed by a user.

In step S2500, if the orbit prediction error exceeds the predetermined orbit error, the satellite maneuver detection apparatus 1000 based on Neural Controlled Differential Equations may determine whether the predicted orbit information exceeds a predetermined maneuver threshold by comparing the predicted orbit information with the predetermined maneuver threshold.

In an embodiment, the satellite maneuver detection apparatus 1000 based on Neural Controlled Differential Equations may compare a semi-major axis error included in the predicted orbit information with the predetermined maneuver threshold.

In an embodiment, to determine the satellite maneuver status, the satellite maneuver detection apparatus 1000 based on Neural Controlled Differential Equations may convert the predicted orbit information into frequency domain information through a Fourier transform. The satellite maneuver detection apparatus 1000 based on Neural Controlled Differential Equations may calculate a spectral residual for the semi-major axis error from the predicted orbit information converted to the frequency domain. The satellite maneuver detection apparatus 1000 based on Neural Controlled Differential Equations may convert the calculated spectral residual back into time domain information by performing a reverse Fourier transform. The satellite maneuver detection apparatus 1000 based on Neural Controlled Differential Equations may compare the spectral residual value converted to the time domain with the predetermined maneuver threshold.

In an embodiment, the satellite maneuver detection apparatus 1000 based on Neural Controlled Differential Equations may calculate a spectral residual for the semi-major axis error and compare it with the predetermined maneuver threshold.

In an embodiment, the predetermined maneuver threshold may be set based on a spectral residual value for the semi-major axis error that occurs during a satellite maneuver.

In step S2600, if the orbit prediction error exceeds the predetermined maneuver threshold, the satellite maneuver detection apparatus 1000 based on Neural Controlled Differential Equations may determine that the satellite has performed a maneuver.

In an embodiment, if the spectral residual for the semi-major axis exceeds the predetermined maneuver threshold, the satellite maneuver detection apparatus 1000 based on Neural Controlled Differential Equations may determine that the satellite has performed a maneuver.

In an embodiment, if it is determined that the satellite has maneuvered, the satellite maneuver detection apparatus 1000 based on Neural Controlled Differential Equations may output the result through a display device or an audio device so that the user may visually or audibly recognize the satellite maneuver.

FIG. 3 is a diagram for explaining a method of training a Neural Controlled Differential Equations-based model according to an embodiment.

Hereinafter, the method will be described as being performed by the satellite maneuver detection apparatus 1000 based on Neural Controlled Differential Equations illustrated in FIG. 1, by way of example.

In step S3100, the satellite maneuver detection apparatus 1000 based on Neural Controlled Differential Equations may collect training data used to train the Neural Controlled Differential Equations-based model.

In an embodiment, the training data may be time-series data obtained by collecting observed orbit information of a satellite during a predetermined time interval.

In step S3200, the satellite maneuver detection apparatus 1000 based on Neural Controlled Differential Equations may determine whether there is missing training data. Specifically, the satellite maneuver detection apparatus 1000 based on Neural Controlled Differential Equations may determine whether there is a time point where data does not exist or whether some data does not exist within a predetermined time.

In step S3300, the satellite maneuver detection apparatus 1000 based on Neural Controlled Differential Equations may interpolate the missing data in the training data.

In an embodiment, the satellite maneuver detection apparatus 1000 based on Neural Controlled Differential Equations may interpolate by applying Cubic Hermite splines based on the observed orbit information included in the training data.

In step S3400, the satellite maneuver detection apparatus 1000 based on Neural Controlled Differential Equations may perform normalization on the training data.

In an embodiment, the satellite maneuver detection apparatus 1000 based on Neural Controlled Differential Equations may perform normalization on the interpolated training data.

In step S3500, the satellite maneuver detection apparatus 1000 based on Neural Controlled Differential Equations may perform conversion to convert the normalized training data into a data form that may be input to the Neural Controlled Differential Equations-based model.

In step S3600, the satellite maneuver detection apparatus 1000 based on Neural Controlled Differential Equations may train the Neural Controlled Differential Equations-based model based on the training data. At this time, in training the Neural Controlled Differential Equations-based model, the satellite maneuver detection apparatus 1000 based on Neural Controlled Differential Equations may tune hyper-parameters to be suitable for satellite orbit information.

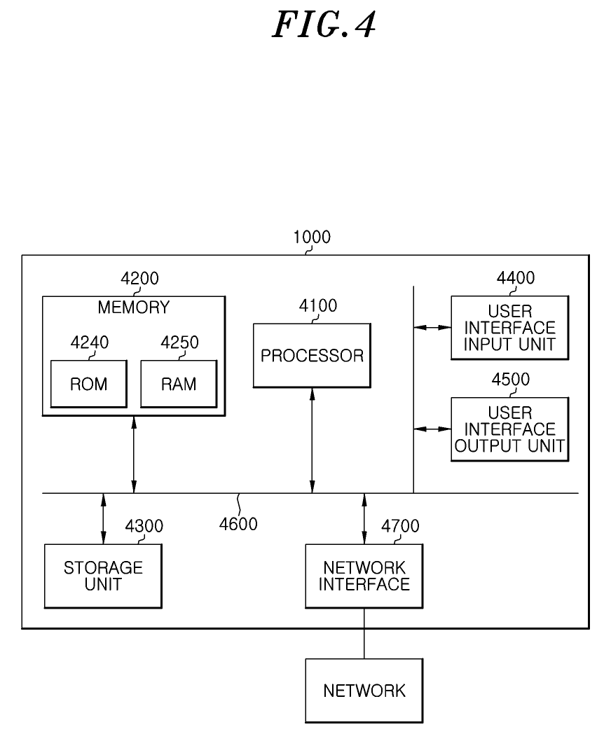

FIG. 4 is a block diagram of a satellite maneuver detection apparatus based on Neural Controlled Differential Equations according to another embodiment.

As illustrated in FIG. 4, the satellite maneuver detection apparatus 1000 based on Neural Controlled Differential Equations may include at least one of a processor 9100, a memory 9200, a storage 9300, a user interface input unit 9400, and a user interface output unit 9500, and these elements may communicate with each other via a bus 9600. In addition, the satellite maneuver detection apparatus 1000 based on Neural Controlled Differential Equations may also include a network interface 9700 for accessing a network. The processor9100 may be a CPU or a semiconductor device that executes processing instructions stored in the memory 9200 and/or the storage 9300. The memory 9200 and the storage 9300 may include various types of volatile/non-volatile memory media. For example, the memory may include a ROM 9240 and a RAM 9250.

The apparatus described above may be implemented as hardware components, software components, and/or a combination of hardware components and software components. For example, the apparatus and components described in the embodiments may be implemented using one or more general-purpose computers or special-purpose computers, such as, for example, a processor, a controller, an arithmetic logic unit (ALU), a digital signal processor, a microcomputer, a field programmable array (FPA), a programmable logic unit (PLU), a microprocessor, or any other device capable of executing and responding to instructions. The processing device may run an operating system (OS) and one or more software applications that run on the operating system.

In addition, the processing device may access, store, manipulate, process, and generate data in response to the execution of software. For convenience of understanding, there are cases where the processing device is described as being used as a single unit, but those skilled in the art will recognize that the processing device may include a plurality of processing elements and/or a plurality of types of processing elements. For example, the processing device may include a plurality of processors or one processor and one controller. Also, other processing configurations such as parallel processors are possible.

The software may include a computer program, code, instructions, or a combination of one or more of these, and may configure the processing device to operate as desired or may command the processing device independently or collectively. The software and/or data may be permanently or temporarily embodied in any type of machine, component, physical device, virtual equipment, computer storage medium or device, or transmitted signal wave, to be interpreted by the processing device or to provide instructions or data to the processing device. The software may be distributed over a networked computer system and stored or executed in a distributed manner. The software and data may be stored on one or more computer-readable recording media.

The above description is merely illustrative of the technical spirit of the disclosure, and various modifications and variations will be possible without departing from the essential quality of the disclosure by those skilled in the art to which the disclosure pertains. Therefore, the embodiments disclosed herein are not intended to limit the technical spirit of the disclosure but to explain it, and the scope of the technical spirit of the disclosure is not limited by these embodiments. The scope of protection of the disclosure should be interpreted by the following claims, and all technical ideas within the scope equivalent thereto should be interpreted as being included in the scope of rights of the disclosure.

What is claimed is:

1. A method for detecting a satellite maneuver using a Neural Controlled Differential Equations (NCDE)-based model to be performed by a satellite maneuver detection apparatus based on Neural Controlled Differential Equations, the method comprising:
acquiring observed orbit information of a satellite collected up to a target time;
generating predicted orbit information of the satellite for a time after the target time using a pre-trained satellite orbit prediction model, based on the observed orbit information of the satellite collected up to the target time;
generating an orbit prediction error by comparing the observed orbit information of the satellite collected after the target time with the predicted orbit information; and
determining the satellite maneuver status upon the orbit prediction error exceeding a predetermined error threshold.

2. The method of claim 1, wherein the pre-trained satellite orbit prediction model is a model generated by training the NCDE-based model based on the observed orbit information of the satellite collected during a predetermined time interval.

3. The method of claim 2, wherein the pre-trained satellite orbit prediction model is a model generated by training the NCDE-based model based on interpolated observed orbit information, which is obtained by interpolating missing data based on Cubic Hermite splines, if there are time points with missing data in the observed orbit information of the satellite collected during the predetermined time interval.

4. The method of claim 3, wherein the pre-trained satellite orbit prediction model is a model generated by normalizing the interpolated observed orbit information and training the NCDE-based model.

5. The method of claim 4, wherein the pre-trained satellite orbit prediction model is a model generated by normalizing the interpolated observed orbit information, converting the normalized information into a fixed-sized sequence using a sliding window technique, and then training the NCDE-based model.

6. The method of claim 1, wherein the generating the orbit prediction error includes generating the prediction error based on Mean Squared Error (MSE).

7. The method of claim 1, wherein the determining the satellite maneuver status includes determining the satellite maneuver status based on a semi-major axis error included in the predicted orbit information.

8. The method of claim 7, wherein the determining the satellite maneuver status includes determining that the satellite has maneuvered upon a spectral residual for the semi-major axis error exceeding a predetermined maneuver threshold.

9. The method of claim 8, wherein the predetermined maneuver threshold is set based on a spectral residual value for the semi-major axis error that occurs during a satellite maneuver.

10. A satellite maneuver detection apparatus based on a Neural Controlled Differential Equations (NCDE)-based model, the apparatus comprising:
a memory including instructions; and
a processor configured to execute the instructions to:
acquire observed orbit information of a satellite collected up to a target time;
generate predicted orbit information of the satellite for a time after the target time using a pre-trained satellite orbit prediction model, based on the observed orbit information of the satellite collected up to the target time;
generate an orbit prediction error by comparing the observed orbit information of the satellite collected after the target time with the predicted orbit information; and
determine the satellite maneuver status upon the orbit prediction error exceeding a predetermined error threshold.

11. The apparatus of claim 10, wherein the pre-trained satellite orbit prediction model is a model generated by training the NCDE-based model based on the observed orbit information of the satellite collected during a predetermined time interval.

12. The apparatus of claim 11, wherein the pre-trained satellite orbit prediction model is a model generated by training the NCDE-based model based on interpolated observed orbit information, which is obtained by interpolating missing data based on Cubic Hermite splines, if there are time points with missing data in the observed orbit information of the satellite collected during the predetermined time interval.

13. The apparatus of claim 12, wherein the pre-trained satellite orbit prediction model is a model generated by normalizing the interpolated observed orbit information and training the NCDE-based model.

14. The apparatus of claim 13, wherein the pre-trained satellite orbit prediction model is a model generated by normalizing the interpolated observed orbit information, converting the normalized information into a fixed-sized sequence using a sliding window technique, and then training the NCDE-based model.

15. The apparatus of claim 10, wherein the processor generates the prediction error based on Mean Squared Error (MSE).

16. The apparatus of claim 10, wherein the processor determines the satellite maneuver status based on a semi-major axis error included in the predicted orbit information.

17. The apparatus of claim 16, wherein the processor determines that the satellite has maneuvered when a spectral residual for the semi-major axis error exceeds a predetermined maneuver threshold.

18. The apparatus of claim 17, wherein the predetermined maneuver threshold is set based on a spectral residual value for the semi-major axis error that occurs during a satellite maneuver.

19. A non-transitory computer-readable recording medium storing a computer program, the medium comprising instructions for causing a processor to perform a method comprising:
acquiring observed orbit information of a satellite collected up to a target time;
generating predicted orbit information of the satellite for a time after the target time using a pre-trained satellite orbit prediction model, based on the observed orbit information of the satellite collected up to the target time;
generating an orbit prediction error by comparing the observed orbit information of the satellite collected after the target time with the predicted orbit information; and
determining the satellite maneuver status upon the orbit prediction error exceeding a predetermined error threshold.

20. The non-transitory computer-readable recording medium of claim 19, wherein the pre-trained satellite orbit prediction model is a model generated by training the NCDE-based model based on the observed orbit information of the satellite collected during a predetermined time interval.
